(19) United States
(12) Patent Application Publication
(10) Pub. No.: US 2014/0118408 A1
(43) Pub. Date: May 1, 2014

(54) MANAGEMENT SYSTEM FOR UNIFYING LED LIGHT COLOR AND METHOD THEREOF

(71) Applicants: CHIEN LEE, NEW TAIPEI CITY (TW); YUNG-HONG WANG, TAIPEI CITY (TW)

(72) Inventors: CHIEN LEE, NEW TAIPEI CITY (TW); YUNG-HONG WANG, TAIPEI CITY (TW)

(21) Appl. No.: 13/746,326

(22) Filed: Jan. 22, 2013

(30) Foreign Application Priority Data
Oct. 30, 2012 (TW) 101140080

(51) Int. Cl. G09G 5/02

(52) U.S. Cl. CPC G09G 5/02
USPC 345/690

(57) ABSTRACT

In a management system and a method for unifying LED light color, light colors are projected from a plurality of display units, and each display unit has at least one LED having a color coordinate and a brightness value. The system and method read the color coordinate and the brightness value and compare the color coordinate and the brightness value with a predetermined color coordinate and a predetermined brightness value respectively to produce a coordinate variation value of each LED to correct a duty ratio of a PWM signal of the display unit, so as to adjust a driving current of each LED and move the color coordinate to a position corresponding to the predetermined color coordinate. Therefore, each LED can show the same primary colors through a software calibration without having any chromatic aberration of mixed lights, so as to improve the display effect.

### CROSS-REFERENCE TO RELATED APPLICATIONS

This non-provisional application claims priority under 35 U.S.C. §119(a) on Patent Application No(s). 101140080 filed in Taiwan, R.O.C. on Oct. 30, 2012, the entire contents of which are hereby incorporated by reference.

### BACKGROUND OF THE INVENTION

1. Field of the Invention

The present invention relates to the technical field of a chromatic aberration calibration system for light emitting diodes (LEDs), and more particularly to a management system and a method for unifying LED light color that use a software calibration method to show the same primary colors for LEDs of the same color, so as to improve the quality of mixed lights and achieve a chromatic aberration free effect.

2. Description of the Related Art

Color gamut is defined as a maximum range for a device such as a display device, a printer or printing machine to show most colors, and the concept of color gamut is illustrated intuitively by the CIE-xy chromaticity diagram established by Commission International de I'Eclarrage (CIE), and therefore two-dimensional scales are used for defining a color range that a device can show. In an LED display device, LEDs with three different primary colors (red, green and blue) are arranged and combined into a light emitting source, and lights of the three primary colors are mixed in different ratios to show the colors of a projected light. In the CIE-xy chromaticity diagram, the upper limit that a display device can show the red light, green light or blue light is marked at a corresponding position on the scale, and these three point are connected to form three lines and a triangular area enclosed by the three straight lines, and the triangular area is the range of the color gamut of the display device. The larger the triangular area, the broader is the range of the color gamut.

For example, a large screen comprised of a plurality of LED panels a, b, c, d is installed on a building. Taking the consistency of the colors displayed on the display screen, the range of the color gamut of each panel must be identical, so that the panels must be manufactured by LEDs with the same luminance and chrominance. However, the LEDs manufactured by the same factor may still have different Bin code and show different primary colors (RGB) as shown in FIG. 1, so that the panels have different ranges of the color gamut. Now, each panel mixes 30% of the red light, 80% of the green light and 20% of the blue light to produce projecting lights Ta, Tb, Tc, Td which have a different chrominance from one and other to result in the chromatic aberration problem of the screen and affect the display quality.

To overcome the aforementioned problem, manufacturers generally choose the LED of the same branded and the same Bin as the manufacturing part, but it is difficult to carry the plan with a low cost, due to the limitation of the supply and yield rate of the parts.

Therefore, it is a main subject for the present invention to overcome the chromatic aberration issue of each LED panel while taking the cost into consideration.

### SUMMARY OF THE INVENTION

In view of the problems of the prior art, it is a primary objective of the present invention to provide a management system and a method for unifying LED light color, wherein the light colors projected by a plurality of LED panels or lamps are unified when they are used at the same time for displaying a screen, so as to improve the screen display quality and satisfy visual requirements.

To achieve the aforementioned objective, the present invention provides a management system for unifying LED light color, and the management system comprises a plurality of display units, a processing unit and a correction unit, wherein the processing unit has a plurality of predetermined color coordinates and a plurality of predetermined brightness values, and the processing unit is electrically coupled to the display units and the correction unit. Each display unit has at least one LED, and the LED has a color coordinate and a brightness value. The management method of the management system comprises the steps of: detecting the plurality of display units and determining whether a color coordinate and a brightness value of the LED are recorded; reading the color coordinate and the brightness value and comparing the color coordinate with a corresponding predetermined color coordinate and the brightness value with a corresponding predetermined brightness value if the display unit has recorded the color coordinate and the brightness value; computing and obtaining a coordinate variation value of the LED; the correction unit is receiving and using the coordinate variation value to correct a duty ratio of a PWM signal and adjust a driving current to move the color coordinate to a position corresponding to the predetermined color coordinate.

Wherein, the LEDs have a light emitting color source with a wavelength of a red light from 610 nm to 670 nm, a wavelength of a green light from 510 nm to 550 nm, and a wavelength of a blue light from 440 nm to 490 nm, and the color coordinate is a two-dimensional scale of a CIE Color System, and the brightness value is divided into 0˜n levels, where n falls within a range of 50˜1000.

In addition, when the LED exits a factory, the color coordinate and the brightness value are examined, and the color coordinate and the brightness value are saved into the display unit. Alternatively, if the display unit has not recorded the color coordinate and the brightness value, the management system further detects the LED by a detection unit to obtain and record the color coordinate and the brightness value.

To assure the range of color gamut of the display units meets the actual requirements, the predetermined color coordinate and the predetermined brightness value are set as default parameter values. Alternatively, the processing unit integrates the color coordinates and the brightness values to generate a coordinate set and a brightness set of a red light, a green light and a blue light; and computing each coordinate set and each brightness set to obtain average values to generate the predetermined color coordinate and the predetermined brightness value. Therefore, an intersection value can be obtained from a characteristic difference between the display units to flexibly define an appropriate range of the color gamut and simplify the operation of the system.

In summation, the present invention adjust the color coordinate of each LED to a default coordinate value by a software program to unify the chrominance of the primary colors of the LEDs installed to different display units. Therefore, the display units can have the same range of the color gamut without incurring a high cost, so as to improve the economic benefit.

### BRIEF DESCRIPTION OF THE DRAWINGS

FIG. 1 is a schematic view, showing the chromatic aberration between a plurality of panels of a prior art;

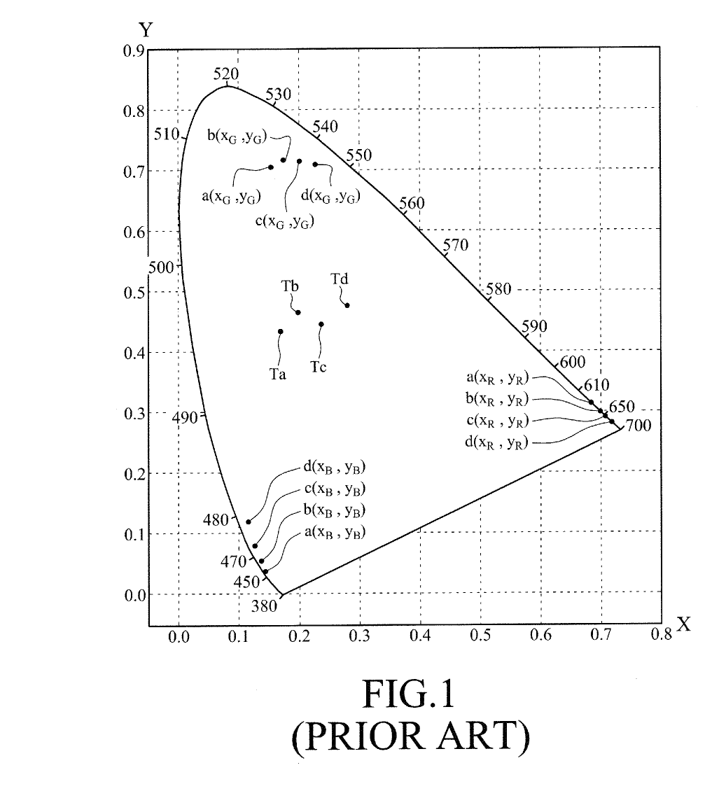

FIG. 2 is a schematic block diagram of a first exemplary mode of a system in accordance with a preferred embodiment of the present invention;

FIG. 3 is a schematic block diagram of a second exemplary mode of a system in accordance with a preferred embodiment of the present invention; and

FIG. 4 is a flow chart of a second exemplary mode of a method in accordance with a preferred embodiment of the present invention; and

FIG. 5 is a schematic view of an application of a second exemplary mode in accordance with a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

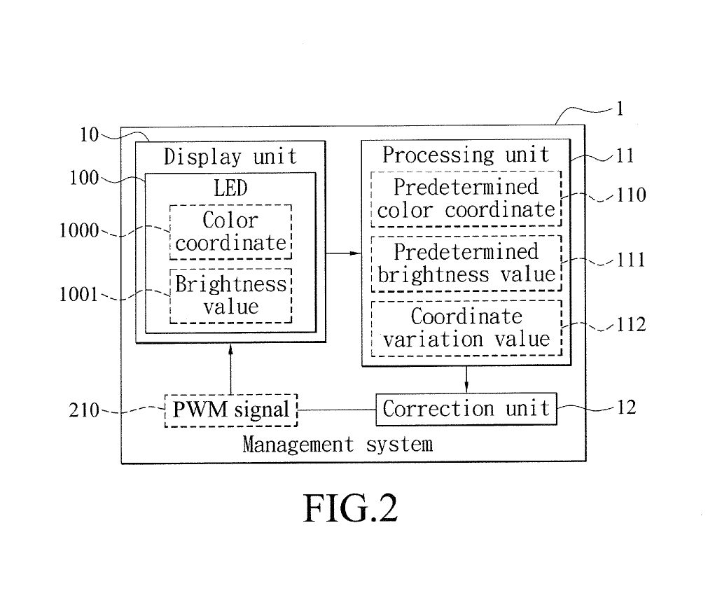

With reference to FIG. 2 for a schematic block diagram of a first exemplary mode of a management system 1 for unifying LED light color in accordance with a preferred embodiment of the present invention, the management system 1 comprises a plurality of display units 10, a processing unit 11 and a correction unit 12, wherein each display unit 10 includes at least one LED 100 and is electrically coupled to the processing unit 11, and the LED has a color coordinate 1000 and a brightness value 1001. The processing unit 11 is electrically coupled to the correction unit 12 and has a plurality of predetermined color coordinates 110 and a plurality of predetermined brightness values 111. After the processing unit 11 reads the color coordinate 1000 and the brightness value 1001 of the LEDs 100, the processing unit 11 compares the color coordinate 1000 and the brightness value 1001 with the corresponding predetermined color coordinate 110 and predetermined brightness value 111 to compute and obtain a coordinate variation value 112 of each LED 100. In addition, the correction unit 12 receives the coordinate variation value 112 to correct a duty ratio of a PWM signal 210 and adjust a driving current of each LED 100, so as to move the color coordinate 1000 to a position corresponding to the predetermined color coordinate 110. Therefore, the primary colors and light intensity of the LEDs 100 are consistent and the chrominance of the projected light of the display units 10 can be unified.

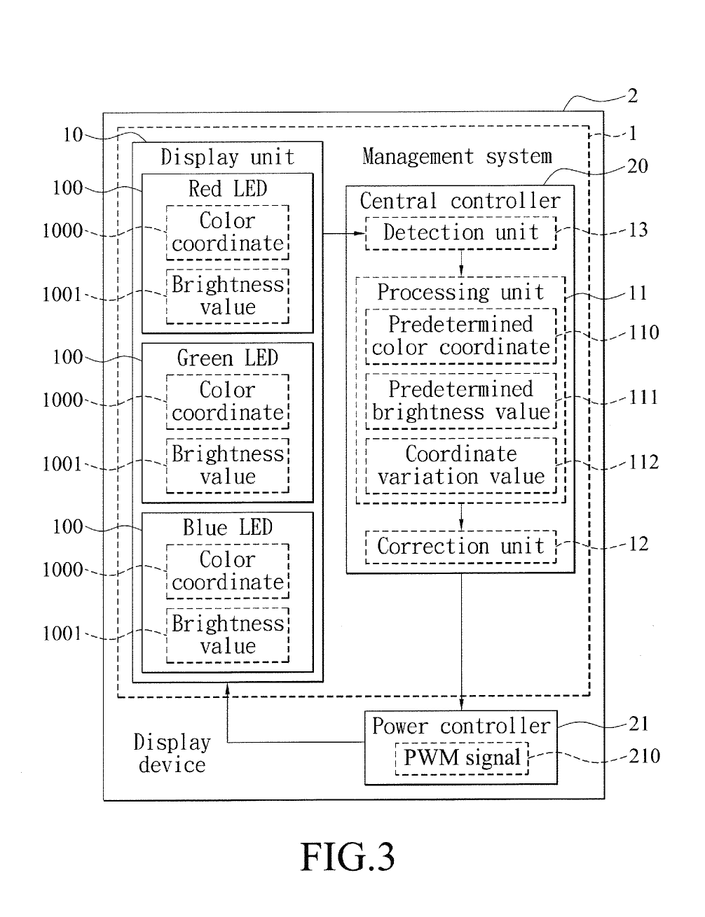

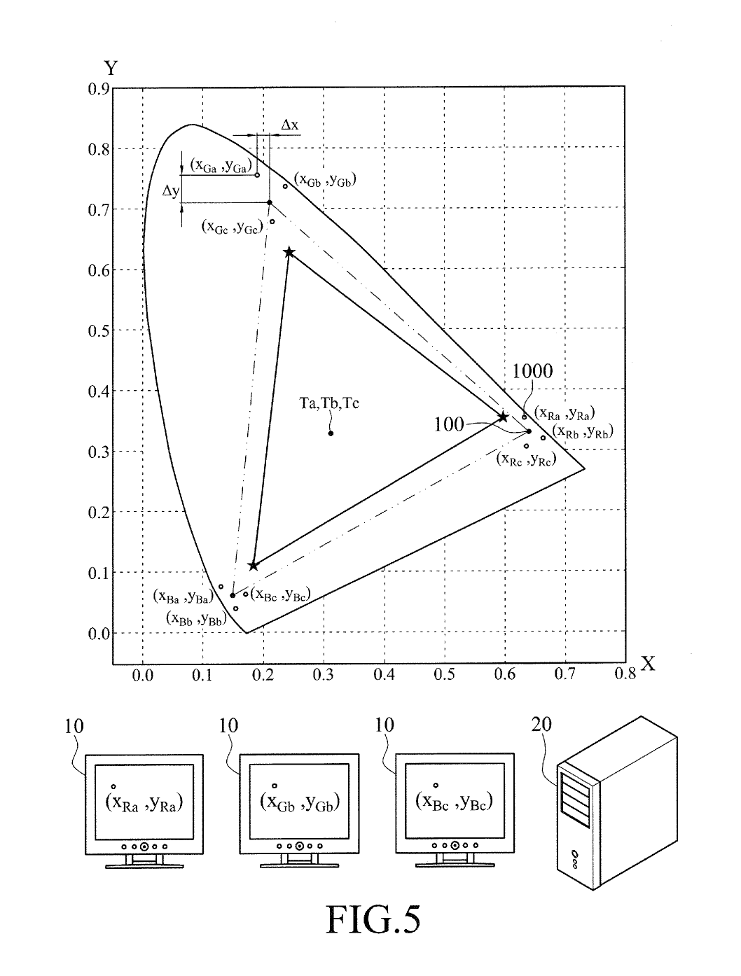

With reference to FIGS. 3 to 5 for a schematic block diagram of a management system, a flow chart of a management method and a schematic view of the management system of the second exemplary mode in accordance with a preferred embodiment of the present invention respectively, the management system of the present invention can be installed to an LED display device 2 such as a large-size LED screen, an LED curtain wall or an LED floor of an arena, a stadium or an office building or a plurality of screens a, b, c installed to a same operating platform, or any illumination device that can apply the technical measures of the present invention, and the management system can unify the chrominance of the displayed colors of a plurality of LED panels, lamps or screens to improve the screen display quality and sophistication. Therefore, the display units 10 can be the aforementioned LED panels, lamps or screens, and the LEDs 100 are comprised of red light LEDs with a wavelength of 610 nm˜670 nm, green light LEDs with a wavelength of 510 nm˜550 nm and blue light LEDs with a wavelength of 440 nm˜490 nm. The processing unit 11 and the correction unit 12 are software programs installed in a central controller 20 of the LED display device 2, and the correction unit 12 is electrically coupled to a power controller 21 of the LED display device 2. In addition, the management system 1 further comprises a detection unit 13 electrically coupled to the display units 10 and the processing unit 11, and the detection unit 13 also can be a software program installed in the central controller 20. The management method of the management system 1 comprises the following steps after the management system 1 is started:

S1: The detection unit 13 detects each display unit 10 to check whether the color coordinate 1000 and the brightness value 1001 are recorded such as the color coordinate 1000 and the brightness value 1001 recorded in a built-in memory device of the screen. If no, go to Step S10.

S10: After the detection unit 13 detects each LED 100 to obtain the color coordinate 1000 and the brightness value 1001, the color coordinate 1000 and the brightness value 1001 are recorded into the central controller 20 installed at an LED wall or an operating platform.

If yes, go to the next step. It is noteworthy that the color coordinate 1000 is a two-dimensional scale of a CIE color system and labeled as (xᵢ, yᵢ), wherein i represents a red light (R), a green light (G) or a blue light (B), and the predetermined color coordinates 110 are target chrominance (x_{—}_{^{R}}, y_{—}_{^{R}}), (x_{—}_{^{G}}, y_{—}_{^{G}}) and (x_{—}_{^{B}}, y_{—}_{^{B}}) of the red, green blue lights when the LEDs are 100% lit for specifying three primary colors and defining the required range of the color gamut. The brightness values 1001 of the three primary colors can be labeled as Y divided into 0˜n levels, wherein n falls within a range of 50˜1000.

S2: The processing unit 11 reads the color coordinates 1000 and the brightness values 1001 from the display unit 10 or the central controller 20.

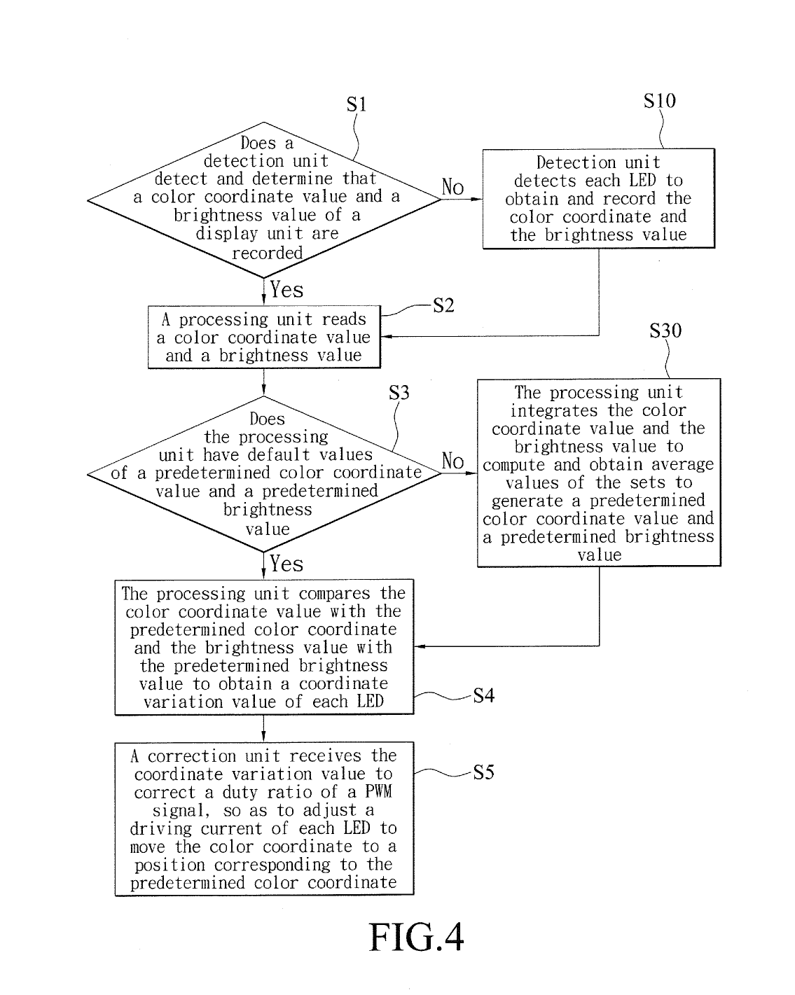

S3: The processing unit 11 self-detects whether there are the predetermined color coordinates 110 and the predetermined brightness values 111. If yes, coordinate parameter values (as indicated by the symbol “|” in the chromaticity diagram as shown in FIG. 4) and brightness parameter values of the corresponding three primary colors are preset which is the step S4.

If no, go to Step S30 as described below.

S30: The processing unit 11 integrates the read color coordinates 1000 and the brightness values 1001 to generate a coordinate set and a brightness set of the three primary colors (including the red light, green light and blue light) and computes each coordinate set and each brightness set to define an intersection of the color coordinates 1000 and an interaction of the brightness values 1001, and then analyzes and obtains an average value of each coordinate set to produce the predetermined color coordinate 110 (indicated by the symbol “•” in the chromaticity diagram as shown in FIG. 4) and obtains an average value of each brightness set to produce the predetermined brightness value 111.

S4: The processing unit 11 compares the color coordinates 1000 with the corresponding predetermined color coordinate 110, and the brightness values 1001 with the corresponding predetermined brightness value 111 to compute and obtain a coordinate variation value 112 of the three primary colors (RGB) of each LED 100 and send the coordinate variation value 112 to the correction unit 12. The coordinate variation value 112 represented by (Δx, Δy) satisfies the following relations:

$$Δ x = \frac{\sum {x}_{i} \frac{{Y}_{i}}{{y}_{i}}}{\sum \frac{{Y}_{i}}{{y}_{i}}} ; and$$

$$Δ y = \frac{\sum {Y}_{i}}{\sum \frac{{Y}_{i}}{{y}_{i}}} .$$

S5: After receiving the coordinate variation value 112, the correction unit 12 corrects a duty ratio of a PWM signal 210 of the power controller 21 to adjust a driving current of each LED 100, and a change of the current drive the color coordinate 1000 to move upwardly with a displacement Ax in the direction of the X-axis in the CIE chromaticity diagram and with a displacement Ay in the direction of the Y-axis to a position corresponding to the predetermined color coordinate 110. Therefore, the management system 1 achieves the effect of showing the consistent primary colors of the LEDs 100 of the same color system through the software calibration. In an application that follows, when the display units 10 mixes 30% of the red light, 80% of the green light and 20% of the blue light to generate projecting lights Ta, Tb, Tc, the projecting lights Ta, Tb, Tc have the same chrominance, and thus overcoming the problem of having a chromatic aberration between the LED panels and lamps on a screen or between the screens of an operating platform to provide a high display quality.

What is claimed is:

1. A management system for unifying LED light color, comprising:
a plurality of display units, each having at least one LED, and the LED having a color coordinate and a brightness value;
a processing unit, having a plurality of predetermined color coordinates and a plurality of predetermined brightness values, and electrically coupled to the display units, and provided for reading the color coordinates and the brightness values and comparing the color coordinates and the brightness values with the corresponding predetermined color coordinates and the predetermined brightness values to compute and obtain a coordinate variation value of each LED; and
a correction unit, electrically coupled to the processing unit, for receiving the coordinate variation value to correct a duty ratio of a PWM signal in order to adjust a driving current of the LED to move the color coordinate to a position corresponding to the predetermined color coordinate.

2. The management system of claim 1, wherein the LEDs have a light emitting color source with a wavelength of a red light from 610 nm to 670 nm, a wavelength of a green light from 510 nm to 550 nm, and a wavelength of a blue light from 440 nm to 490 nm.

3. The management system of claim 2, wherein the color coordinate is a two-dimensional scale of a CIE color system, and the brightness value is divided into 0˜n levels, and n falls within a range of 50˜1000.

4. The management system of claim 3, wherein the color coordinate and the brightness value of the LED are inspected when exiting a factory, and the color coordinate and the brightness value are saved in the display unit.

5. The management system of claim 3, further comprising a detection unit electrically coupled to the display units and the processing unit for detecting each display unit to obtain and record the color coordinate and the brightness value of the LED.

6. The management system of claim 5, wherein the processing unit integrates and reads the color coordinates and brightness values to generate a coordinate set and a brightness set of a red light, a green light and a blue light, and computes each coordinate set and each brightness set to obtain average values to generate the predetermined color coordinate and the predetermined brightness value.

7. The management system of claim 4, wherein the processing unit integrates and reads the color coordinates and brightness values to generate a coordinate set and a brightness set of a red light, a green light and a blue light, and computes each coordinate set and each brightness set to obtain average values to generate the predetermined color coordinate and the predetermined brightness value.

8. A management method of the management system according to claim 1, comprising the steps of:
detecting the plurality of display units and determining whether the color coordinate and the brightness value at least one LED are recorded;
reading the color coordinate and the brightness value and comparing the color coordinate with the corresponding predetermined color coordinate and the brightness value with the corresponding predetermined brightness value if the display unit has recorded the color coordinate and the brightness value;
computing and obtaining the coordinate variation value of the LED; and
using the coordinate variation value to correct the duty ratio of the PWM signal and adjust the driving current to move the color coordinate to the position corresponding to the predetermined color coordinate.

9. The management method of claim 8, wherein the LEDs have a light emitting color source with a wavelength of a red light from 610 nm to 670 nm, a wavelength of a green light from 510 nm to 550 nm, and a wavelength of a blue light from 440 nm to 490 nm.

10. The management method of claim 9, the LED exited from a factory and detected to be having the color coordinate and the brightness value recorded, or ithe display unit has not recorded the color coordinates and the brightness values, further comprising the step of detecting the LED to obtain and record the color coordinate and the brightness value.

11. The management method of claim 10, the predetermined color coordinate and the predetermined brightness value are default parameter values, or after the color coordinates and the brightness values are red, further comprising the steps of: integrating and the color coordinates and brightness values respectively to generate a coordinate set and a brightness set of a red light, a green light and a blue light accordingly; and computing each coordinate set and each brightness set to obtain average values to generate the predetermined color coordinate and the predetermined brightness value.
